(19) United States
(12) Patent Application Publication
(10) Pub. No.: US 2024/0368013 A1
(43) Pub. Date: Nov. 7, 2024

(54) Bioreactor for Home Septic Unit

(71) Applicant: Eros G. Kaw, Pasadena, CA (US)

(72) Inventor: Eros G. Kaw, Pasadena, CA (US)

(21) Appl. No.: 18/655,145

(22) Filed: May 3, 2024

Related U.S. Application Data
(60) Provisional application No. 63/500,577, filed on May 6, 2023.

(51) Int. Cl. C02F 3/12; C02F 1/00; C02F 1/32; C02F 11/02; C02F 101/10; C02F 101/16; C02F 103/00

(52) U.S. Cl. CPC C02F 3/121; C02F 1/001; C02F 1/32; C02F 11/02; C02F 2101/101; C02F 2101/16; C02F 2103/005; C02F 2303/02

(57) ABSTRACT

A bioreactor for home septic unit consisting of a large, multi-stage chamber wherein influent containing raw sewage including tissue and toilet paper flows through a series of treatment stages containing aeration and microbes specific for treatment of chemical waste, biological waste, ammonia, paper and paper products, and other contaminants, the bioreactor also consisting of one or more stages of filtration utilizing sand and/or other filter media.

### RELATED APPLICATIONS

This Application is related to Provisional Patent Application No. 63/500,577 filed May 5, 2023 entitled BIOREACTOR FOR HOME SEPTIC UNIT, Attorney Docket No. PGI-801-P, which is incorporated herein by reference in its entirety, and claims any and all benefits to which it is entitled therefrom.

### FIELD OF THE INVENTION

The present invention is related to bioreactors and in particular bioreactors for use in a home septic systems. More specifically, the invention relates to bioreactor systems adapted to treatment of waste in domestic septic systems.

### BACKGROUND OF THE INVENTION

Subsurface aeration seeks to release bubbles at the bottom of the tank and allow them to rise by the force of gravity. Diffused aeration systems utilize bubbles to aerate as well as mixers to mix the pond. Water displacement from the expulsion of bubbles can cause a mixing action to occur, and the contact between the water and the bubble will result in an oxygen transfer.

Bioreactors are also designed to treat sewage and waste water. In the most efficient of these systems there is a supply of free-flowing, chemically inert media that acts as a receptacle for the bacteria that breaks down the raw sewage. Aerators Supply oxygen to the sewage and media further accelerating breakdown. In the process, the liquids Biochemical Oxygen Demand BOD is reduced sufficiently to render the contaminated water fit for reuse. The biosolids are collected for further processing or dried and used as fertilizer, agricultural feed, etc.

Subsurface aeration, bioreactors and most likely a combination of both are commonly employed to treat sewage water, recycle wastewater and other water treatment applications both industrially or domestically.

However, there currently exists a need for an upgrade for existing septic tank systems that will digest all of the waste produced in domestic septic systems, including paper and other compostable components.

### SUMMARY OF INVENTION AND ADVANTAGES

The septic tank bioreactor unit of the present invention, or “Septic Jockey™” is a groundbreaking wastewater treatment system designed to enhance the efficiency and environmental sustainability of standard American septic tanks. With a daily flow rate capacity of 500 gallons, this innovative system addresses critical issues associated with septic tank maintenance, including the breakdown of sludge, fats, oils, grease (FOG), ammonia, and nitrates. The septic tank bioreactor unit of the present invention operates by eliminating foul odor and effectively reduces Biological Oxygen Demand (BOD) and Chemical Oxygen Demand (COD) using a small linear air pump with a capacity of up to 40 W. The system is structured within a durable stainless steel frame measuring 15 inches in length and width and 6 inches in height. A key component, a tubular seeder reactor or “Biobuddy™” is integrated into the system, featuring media laden with diverse microbes to enhance treatment processes. Overall dimensions of the frame portion can be 10-30 inches in length and width, or more or less, and the height can be 4-12 inches, or more or less. While 1000 gallons is equivalent to about 134 cubic feet, the typical 1000 gallon tank will have overall dimensions of about 5 feet×5 feet×5 feet, or more or less.

Enhanced Treatment Efficiency: The septic bioreactor's innovative design, incorporating the tubular seeder reactor and a small linear air pump, promotes efficient aeration and microbial activity, resulting in the accelerated breakdown of various waste components.

Reduced Odor: The aeration process and facultative microbial treatment, powered by the small linear air pump and supported by the tubular seeder reactor and stainless steel frame, contribute to a significant reduction in foul odors associated with traditional septic tanks.

Lowered BOD and COD: The septic tank bioreactor tank unit, incorporating a small linear air pump, Biobuddy seeder reactor, and a stainless steel frame, effectively lowers Biological Oxygen Demand (BOD) and Chemical Oxygen Demand (COD), promoting a healthier and more sustainable wastewater treatment process. In environmental chemistry, COD is an indicative measure of the amount of oxygen that can be consumed by reactions in a measured solution. It is commonly expressed in mass of oxygen consumed over volume of solution which in SI units is milligrams per litre (mg/L). A COD test can be used to easily quantify the amount of organics in water. The most common application of COD is in quantifying the amount of oxidizable pollutants found in surface water, e.g. lakes and rivers, or wastewater. COD is useful in terms of water quality by providing a metric to determine the effect an effluent will have on the receiving body, much like BOD.

Microbial Diversity: The system leverages facultative microbes from the diverse microbial environment in the tubular seeder reactor, addressing a wide range of waste constituents for comprehensive treatment.

The septic tank bioreactor unit of the present invention, featuring the tubular seeder reactor, represents a groundbreaking advancement in septic tank technology. It offers a sustainable and efficient solution for the treatment of domestic wastewater, with the potential to revolutionize the wastewater treatment industry and provide an environmentally friendly alternative to conventional septic tank systems.

Benefits and features of the invention are made more apparent with the following detailed description of a presently preferred embodiment thereof in connection with the accompanying drawings, wherein like reference numerals are applied to like elements.

### BRIEF DESCRIPTION OF THE DRAWINGS

FIG. 1 is a representative view of construction details and dimensions for an embodiment of a 7-stage bioreactor home septic unit of the present invention.

FIG. 2 is a representative interior view of an embodiment of an 8-stage bioreactor home septic unit of the present invention.

FIG. 3 is a representative exterior view of an embodiment of an 8-stage bioreactor home septic unit of the present invention.

FIG. 4 is a representative schematic view of an embodiment of an 8-stage bioreactor home septic unit of the present invention.

FIGS. 5A and 5B comprise a table showing experimental results obtained from an embodiment of the 8-stage bioreactor home septic unit of the present invention as shown more particularly shown in FIG. 4.

FIG. 6 comprises a photographical representation of experimental results shown in FIGS. 5A and 5B.

FIG. 7 comprises a photographical representation of an embodiment of the bioreactor home septic system of the present invention.

FIGS. 8-11 comprise photographical representations showing the installation of an embodiment of the bioreactor home septic system of the present invention.

FIG. 12A is a representative view of a septic tank bioreactor unit of the present invention.

FIG. 12B is a representative view of a tubular seeder reactor 1210 of the present invention.

FIG. 13A-13F are photographical representations of experimental results obtained from

use of the septic tank bioreactor unit 1200 of the present invention.

FIG. 14A is a table of data from experimental results obtained from use of the septic tank bioreactor unit of the present invention.

FIGS. 14B and 14C are plots of data from experimental results obtained from use of the septic tank bioreactor unit of the present invention.

FIGS. 15A-D are further representations of the component parts of the septic tank bioreactor unit of the present invention and it's configuration in use.

FIG. 16A-16C are representative views of construction details and dimensions for an embodiment of a 150-gallon per day, 5-stage bioreactor “staircase room”-type home septic unit of the present invention.

deleted

FIG. 17A is a representative plan view of construction details and dimensions for an embodiment of a 300-gallon per day, 8-stage bioreactor “Micro STP” home septic unit of the present invention.

FIG. 17B is a representative profile view of construction details and dimensions for an embodiment of a 300-gallon per day, 8-stage bioreactor “Micro STP” home septic unit of the present invention.

FIG. 17C is a representative isometric view of construction details and dimensions for an embodiment of a 300-gallon per day, 8-stage bioreactor “Micro STP” home septic unit of the present invention.

FIGS. 17D-17E are representative partial process flow views of construction details and dimensions for an embodiment of a 300-gallon per day, 8-stage bioreactor “Micro STP” home septic unit of the present invention.

### DETAILED DESCRIPTION OF THE INVENTION

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

### Definition of Terms

Standard Oxygen Transfer Rate [SOTR]—Pounds of oxygen transferred to water per hour [lbs O2/hour]. SOTR is measured in clean water when the dissolved oxygen [DO] concentration is zero at all points in the water volume, the water temperature is 20° C., at a barometric pressure of 1.00 atm [101 kPa].

Standard Aeration Efficiency [SAE]—Standard Oxygen Transfer Rate per unit total power input. SAE is typically expressed as the pounds of oxygen transferred to the water per hour per HP [lbs O2/hour/HPwire], and is sometimes referred to as SAE Wire. SAE is used as a measure of how efficiently an aerator is transferring oxygen.

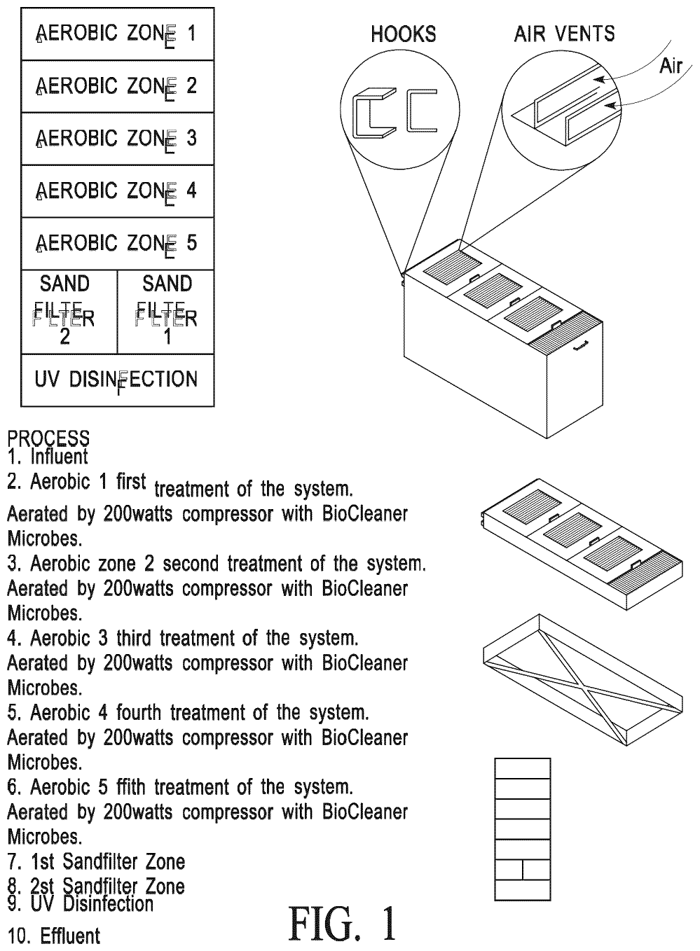

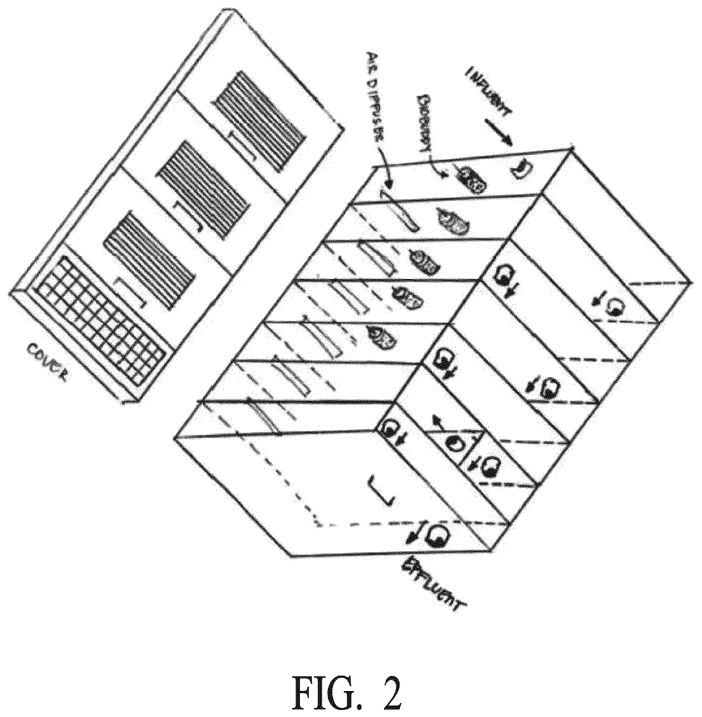

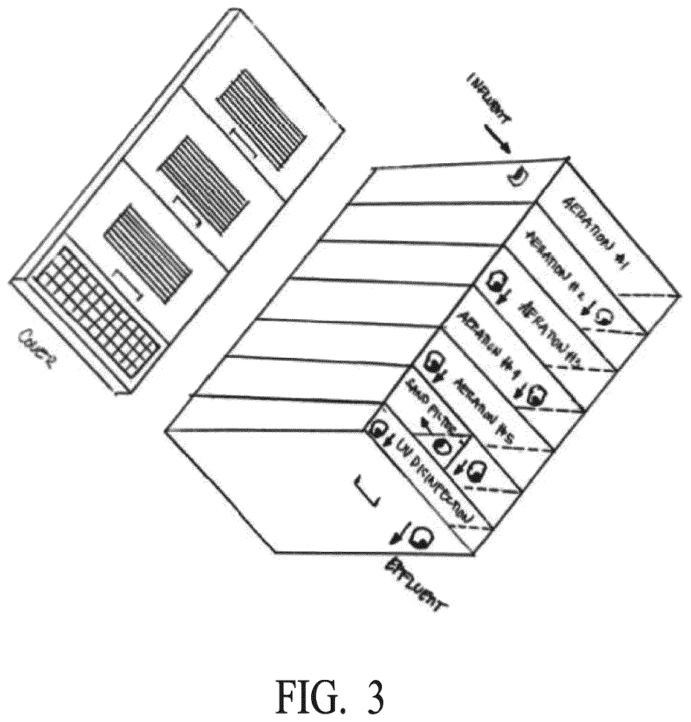

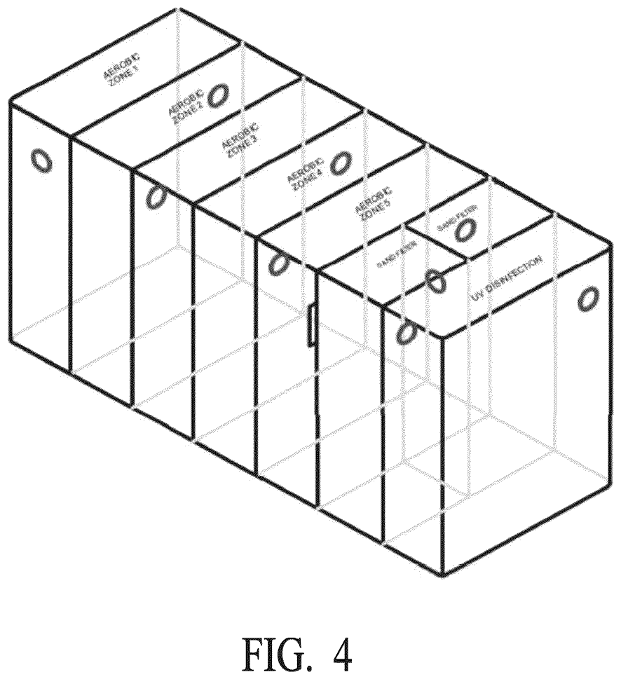

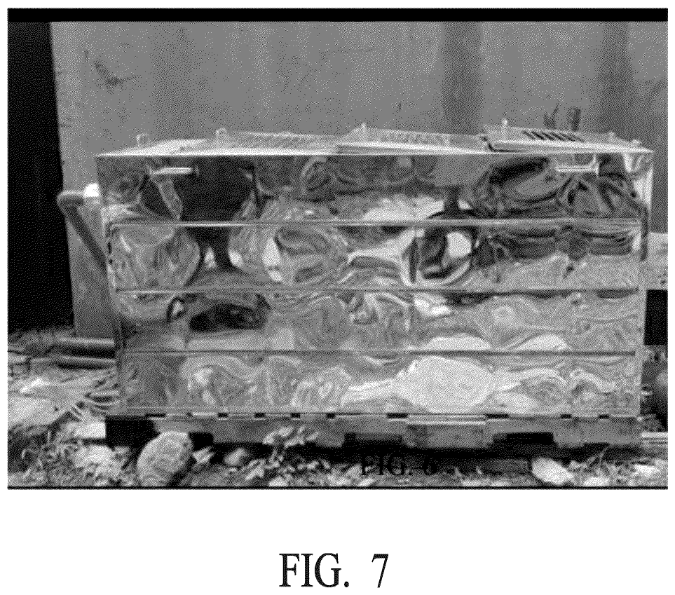

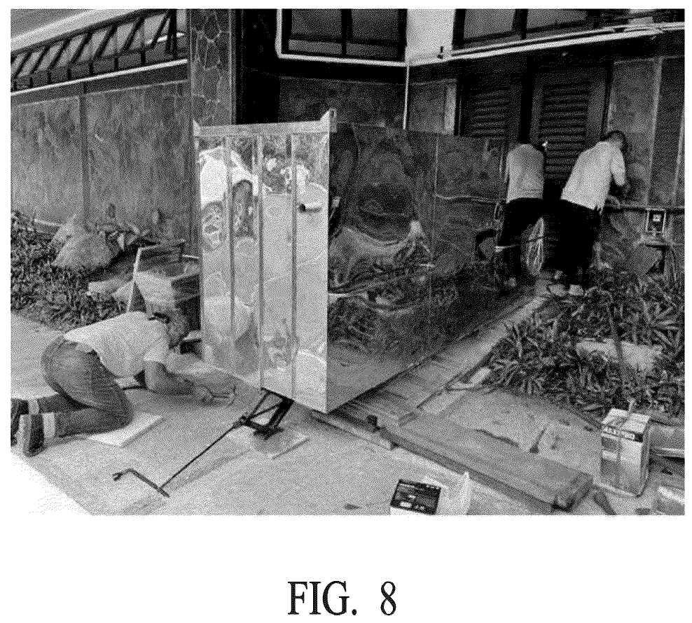

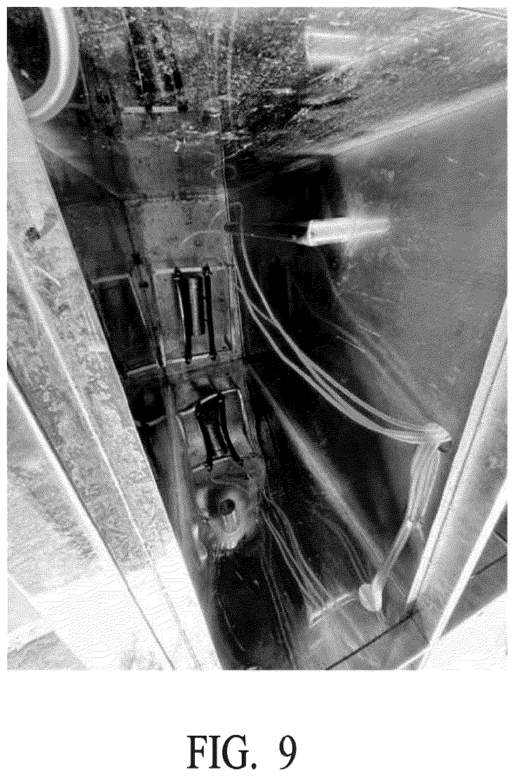

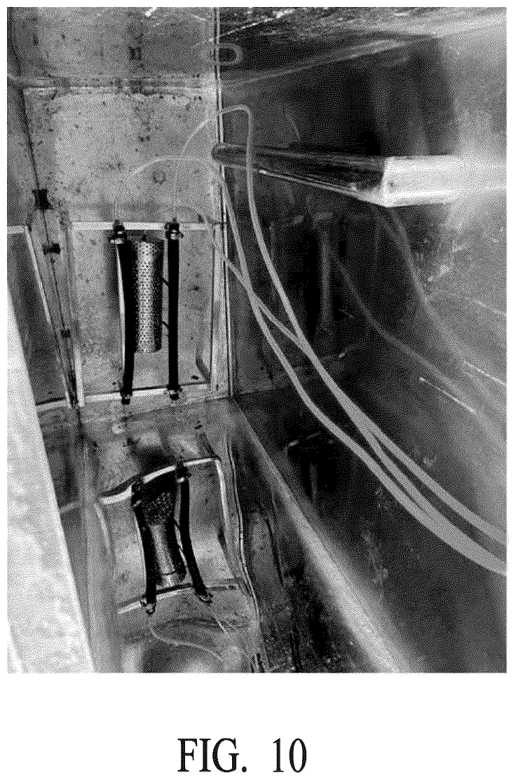

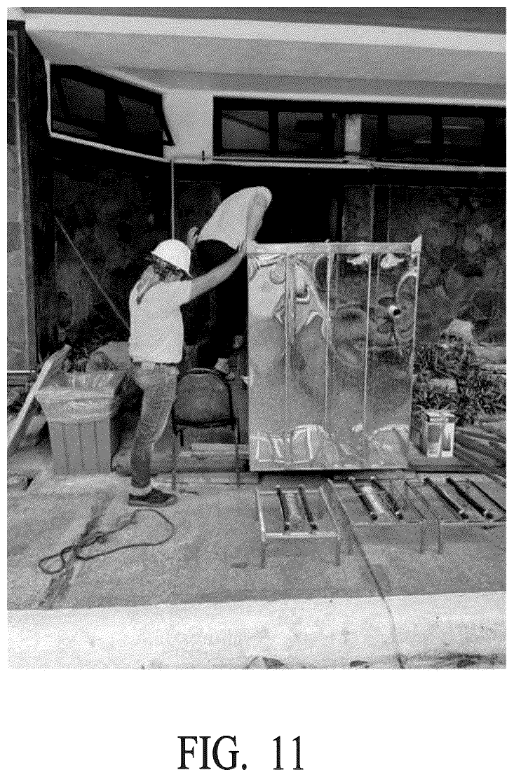

FIG. 1 is a representative view of construction details and dimensions for an embodiment of a 7-stage bioreactor home septic unit of the present invention. FIG. 2 is a representative interior view of an embodiment of an 8-stage bioreactor home septic unit of the present invention. FIG. 3 is a representative exterior view of an embodiment of an 8-stage bioreactor home septic unit of the present invention. FIG. 4 is a representative schematic view of an embodiment of an 8-stage bioreactor home septic unit of the present invention. FIG. 7 comprises a photographical representation of an embodiment of the bioreactor home septic system of the present invention. FIGS. 8-11 comprise photographical representations showing the installation of an embodiment of the bioreactor home septic system of the present invention.

The present invention is a Home Septic Unit. The system comprises a bioreactor. Inside the canister are numerous ceramic pellets. The surface area of the pellets is close to a half an acre of surface are which has been coated with a single layer of predetermined type of microbes. The microbes are Biosafety level 1 microbes, they are saprophytes with various functions.

On top is a heavy metal frame. The system uses aeration hoses which are connected to a tiny blower having about between 150 to 250 Watts of power. A blower system of this size can last for years.

The present Home Septic Unit will produce microbes and treat home septic system. Importantly, it will prevent clogging and digest toilet piper, etc.

The typical home septic system of the present invention comprises 5·6 chambers. The first chamber is the largest and is where solids settle and are partially broken down by bacteria. The second to fifth chambers are where further treatment occurs, and any remaining solids settle out. Some systems have a sand filter and UV disinfection chamber, where the treated wastewater is released into the surrounding soil or through a sewer system.

The home septic system works as follows: It is suspended over the largest chamber, and the aeration hoses are inserted into the chamber. This allows air to flow through the ceramic pellets and encourages the growth of beneficial bacteria. These bacteria break down the organic matter in the wastewater, reducing its strength and preventing clogs in the system.

As the treated wastewater flows from the first chamber to the second and third chambers, etc., the bacteria continue to work, breaking down any remaining organic matter and converting ammonia to nitrates. The Home Septic Unit helps to ensure that this process is efficient, and that any excess nitrogen is removed from the wastewater before it is released into the soil.

So, for any home septic system, the Home Septic Unit of the present invention can help keep it running smoothly and efficiently. and prevent costly repairs or replacement down the road.

### Description of the Process

1. Influent
2. Aerobic zone 1 first treatment of the system. Aerated by 200 watts compressor with

Biocleaner Microbes
3. Aerobic zone 2 second treatment of the system. Aerated by 200 watts compressor with Biocleaner Microbes.
4. Aerobic zone 3 third treatment of the system. Aerated by 200 watts compressor with Biocleaner Microbes.
5. Aerobic zone 4 fourth treatment of the system. Aerated by 200 watts compressor with

Biocleaner Microbes.
6. Aerobic zone 5 fifth treatment of the system. Aerated by 200 watts compressor with Biocleaner Microbes.
7. First Sand filter Zone
8. Second Sand Filter Zone
9. UV Disinfection
10. Effluent

The Home Septc Unit shown in FIGS. 1-4 produces water that can be recycled. The unit processes septic waste influent and the resulting effluent complies with EPA standards for drinking water. The BOD of effluent is nondetectable. The COD in the effluent is less than 1 PPM, far below the WHO standard of COD less than 7 PPM for drinking water. Also, ammonia is less than 0.1 PPM, which also complies with EPA standards on ammonia content in drinking water.

An embodiment of the home septic unit of the present invention consists of 6 chambers, each having microbes, and an additional finishing chamber. Retention time is 4 hours per chamber, with an additional 1-4 hours of polishing, and the overall rate of processing of septic waste is 500 gallons per day.

The present invention utilizes a group of microbes and functional bacteria referred to herein as BioSix microbes. These reduce biological materials in septic waste, reducing the BOD. BioSix breaks down BOD and FOGs, and are found within the first 4 chambers of the home septic unit.

The present invention utilizes another group of microbes and functional bacteria referred to herein as Amon2 microbes. These reduce ammonia and nitrogen-containing materials in septic waste. Amon2 microbes are also found within the first 4 chambers of the home septic unit.

The present invention utilizes another group of microbes and functional bacteria referred to herein as Chem5 microbes. These reduce chemical materials in septic waste, reducing the COD. Chem5 microbes break down a variety of organic and inorganic compounds including but not limited to pharmaceuticals, antibiotics, fertilizers, estrogen and other hormones, petrochemicals, etc., and are found within the 5th chambers of the home septic unit. This chamber is also known as the polishing chamber.

The present invention utilizes another set of filters to remove phosphorous, referred to herein as PhosPhilter. PhosPhilter reduces phosphorous found in septic waste, the sources of which are food, meats, food processing and human waste, etc. The PhosPhilter media comprising limestone and other minerals can be used within any of the various chambers of the home septic unit, but would typically be found in one of the later sand or gravel chambers. The limestone chambers can be flushed, recharged or replaced as needed. EPA standard limits for phosphor are 4 PPM, while the present invention will reduce phosphor to as little as less than 1 PPM.

Subsequent to the polishing chamber, one or more sand and/or gravel chambers, with optional activated charcoal added, denitrify and remove all final traces of nitrogen, ammonia, odor, etc., leaving a clean, clear and odorless effluent.

Other embodiments of the bioreactor for home septic unit of the present invention contain other types of filter media, in addition to and/or in place of the sand. The filter medium used in one or more of the stages of the bioreactor of the present invention can be selected from one or more of the following: sand, stone, ceramic in cast forms, ceramic in granular form, nylon, other polymeric media, iron, other metallic, alloy, composite, and other natural, synthetic or man-made materials.

The home septic unit of the present invention would typically process about 500 gallons of septic waste per day on a continuous flow basis. However, smaller or larger units could process as little as 150 gallons per day or less, to 5000 gallons per day or more. In a preferred embodiment of the present invention, a 40-foot shipping container could be used, providing as much as 60 cubic meters or 15,000 gallons of waste per day. Adding stainless steel panels inside the frame adds strength and rigidity to the unit. Reinforcing steel plates added inside the housing prevent collapse or warping of the overall fram structure.

### Experimental Results

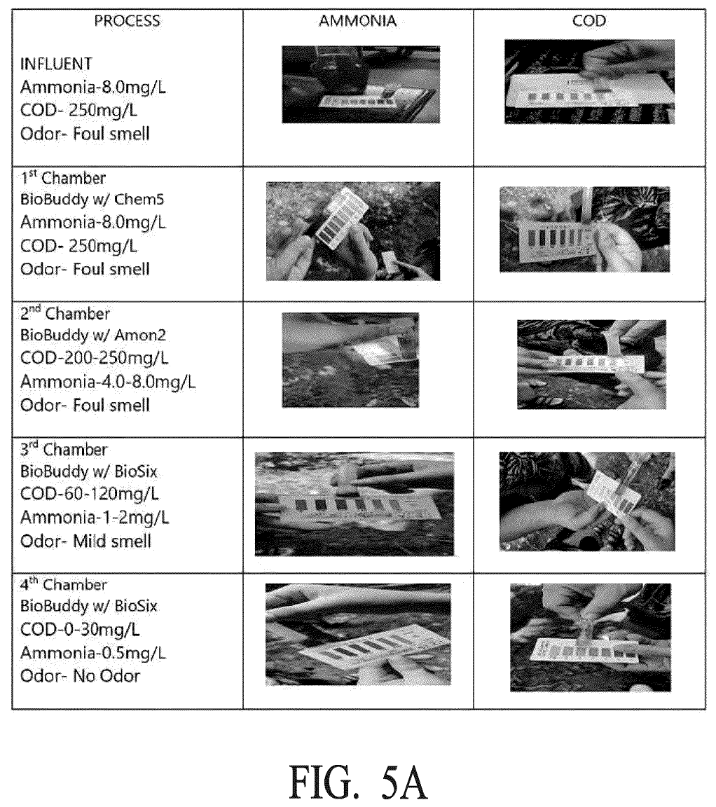

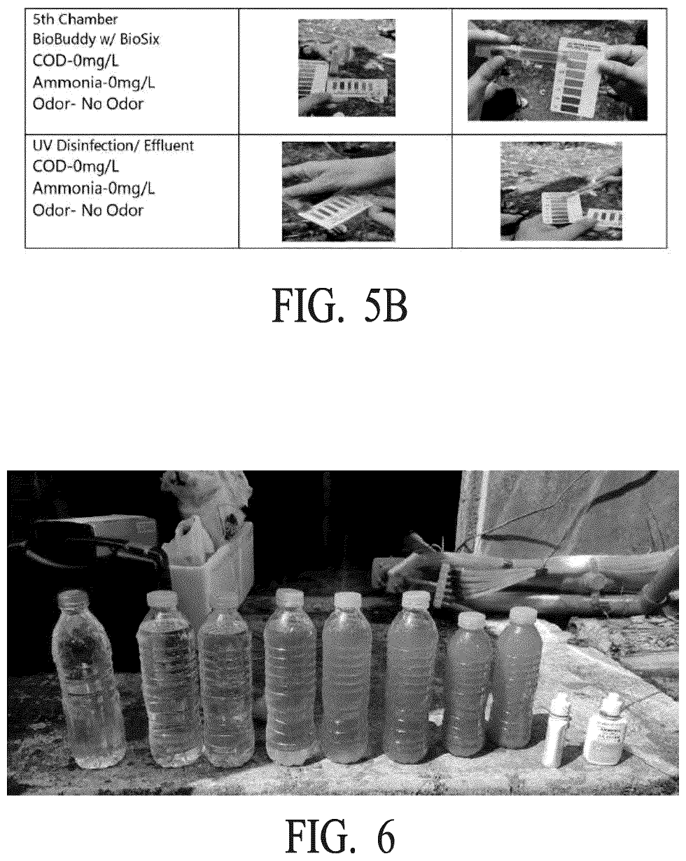

FIGS. 5A and 5B comprise a table showing experimental results obtained from an embodiment of the 8-stage bioreactor home septic unit of the present invention as shown more particularly shown in FIG. 4.

FIG. 6 comprises a photographical representation of experimental results shown in FIGS. 5A and 5B.

This study was conducted to show how the BioCleaner unit functions as a full wastewater treatment system. In December 2021, the BioCleaner unit was used to treat wastewater from Tagaytay Highland Residence. This experiment shows how our device can treat residential and commercial wastewater. This test showed that wastewater from residential areas treated by the

BioCleaner unit meets the parameters tested by the Philippine government. The equipment function properly as monitored consistently with monthly tests.
1. Influent coming from the residence of Tagaytay Highlands. (We also add waste to hit the 1500 mg/L COD)
2. Aerobic zone 1 first treatment of the system. Aerated by 200 watts compressor with Biobuddy Chem5
3. Aerobic zone 2 second treatment of the system. Aerated by 200 watts compressor with Biobuddy Amon2
4. Aerobic zone 3 third treatment of the system. Aerated by 200 watts compressor with

Biobuddy BioSix
5. Aerobic zone 4 fourth treatment of the system. Aerated by 200 watts compressor with Biobuddy BioSix
6. Aerobic zone 5 fifth treatment of the system. Aerated by 200 watts compressor with Biobuddy BioSix
7. 1st Sandfilter Zone
8. 2nd SandFilter Zone
9. UV Disinfection
10. Effluent

### Process

### Influent

Ammonia—8.0 mg/L
COD—250 mg/L
Odor—Foul smell

### Ammonia

### Cod

1st Chamber
BioBuddy w/Chem5
Ammonia—8.0 mg/L
COD—250 mg/L
Odor—Foul smell
2nd Chamber
BioBuddy w/Amon2
COD—200-250 mg/L
Ammonia—4.0-8.0 mg/L
Odor—Foul smell
3rd Chamber
BioBuddy w/BioSix
COD—60-120 mg/L
Ammonia—1-2 mg/L
Odor—Mild smell
4th Chamber
BioBuddy w/BioSix
COD—0-30 mg/L
Ammonia—0.5 mg/L
Odor—No Odor
5th Chamber
BioBuddy w/BioSix
COD—0 mg/L
Ammonia—0 mg/L
Odor—No Odor
UV Disinfection/Effluent
COD—0 mg/L
Ammonia—0 mg/L
Odor—No Odor

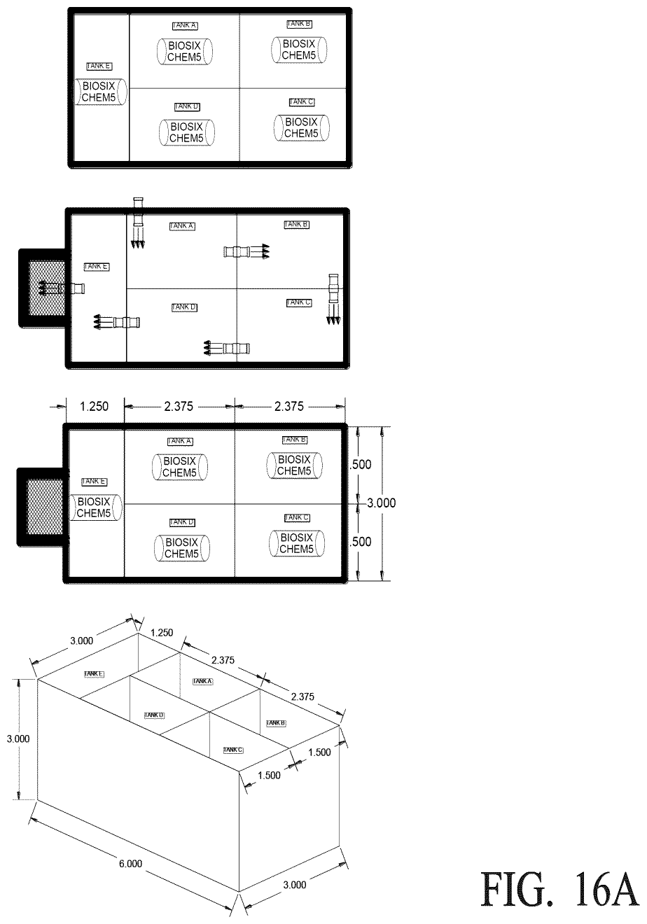

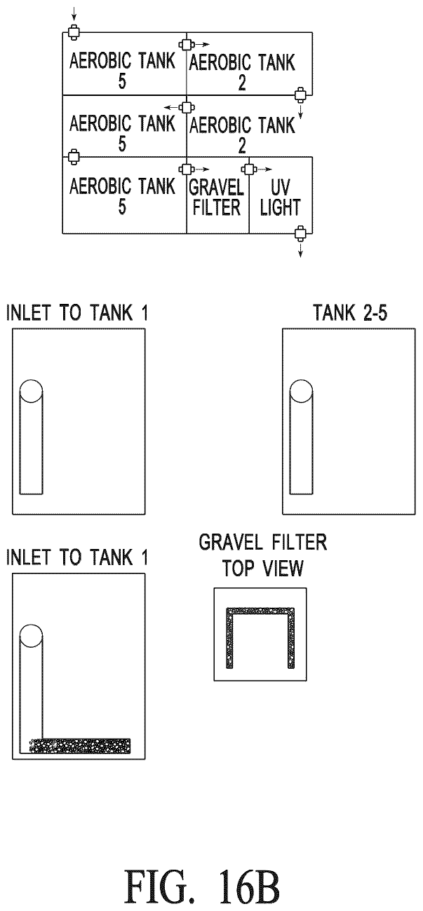

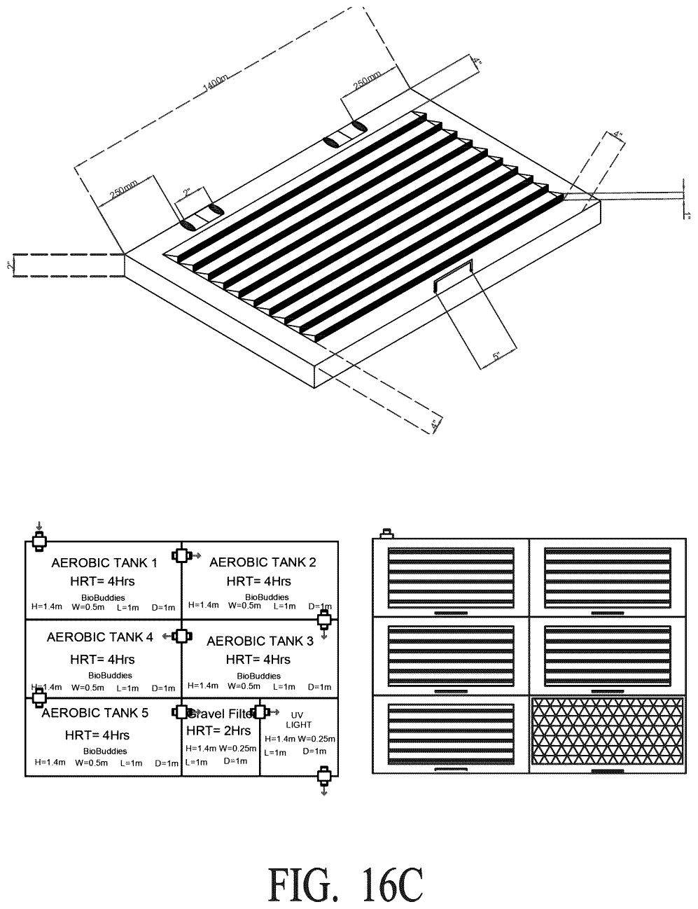

FIG. 16A-16C are representative views of construction details and dimensions for an embodiment of a 150-gallon per day, 5-stage bioreactor “staircase room”-type home septic unit of the present invention. The plan view shows Tanks A-E contain the BioSix and Chem5 microbe sets. The flow diagram shows influent entering Tank A, passing to Tank B, passing to Tank C, passing to Tank D, passing to Tank E and discharging as effluent.

### Tank Dimensions

TANK A,B,C,D: 2.375 ft×1.5 ft×2.5 ft depth=8.9 ft3. 66.5 gallons per tank capacity
TANK E: 1.25 ft×3 ft×2.5 ft depth=9 ft3. 67 gallons capacity

### Hydraulic Retention Time

TANK A=4hrs HRT TANK B=4hrs HRT TANK C=4hrs HRT TANK D=4hrs HRT TANK E=6hrs HRT Dimensions shown in FIG. 16B are in millimeters, or mm. These drawings show the heights of the inlets and outlets between chambers, gravel filter, etc.

Cover details shown in FIG. 16C include dimensions in millimeters.

### Aerobic Tank 1

HRT=4 Hrs

### Aerobic Tank 4

HRT=4 Hrs

### Aerobic Tank 3

HRT=4 Hrs

### Aerobic Tank 5

HRT=2 Hrs
Dimensions of Tank 1-5: H=1.4 m W-0.5 m L=1 m D=1 m
GRAVEL FILTER: H=1.4 m W=0.25 m, L=1 m D=1 m
UV LIGHT H=1.4 m W=0.25 m, L=1 m D=1 m

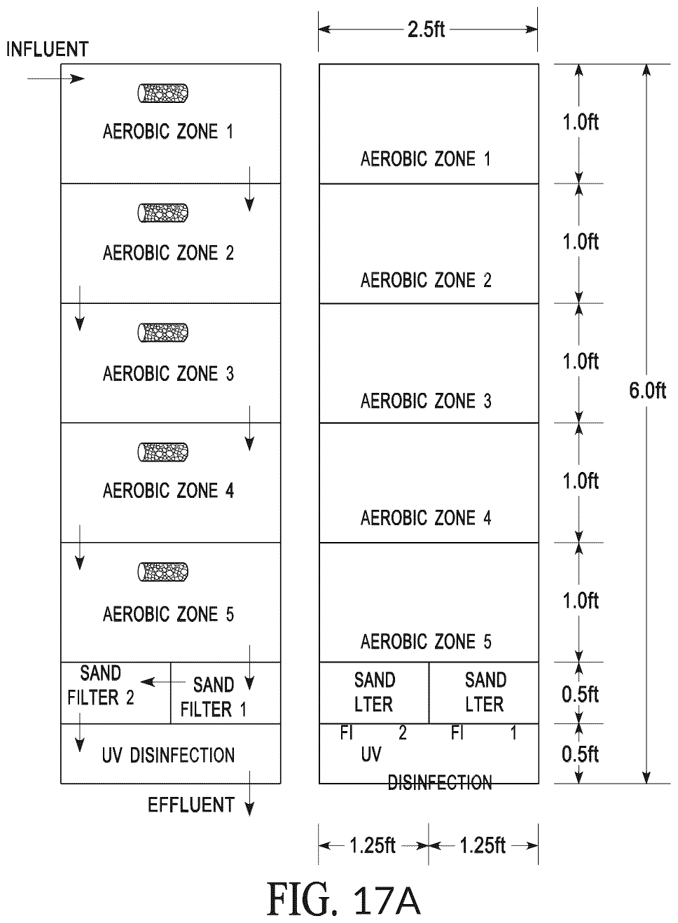

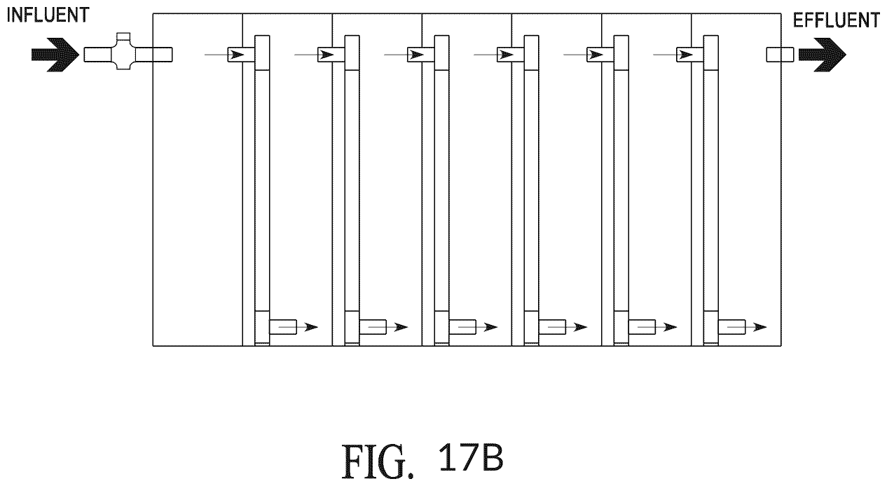

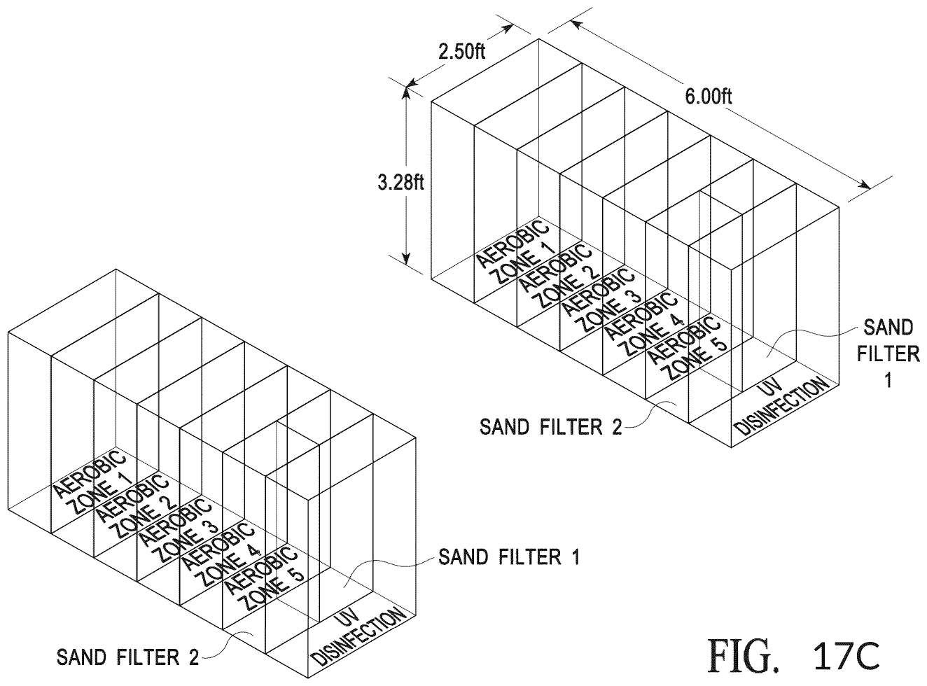

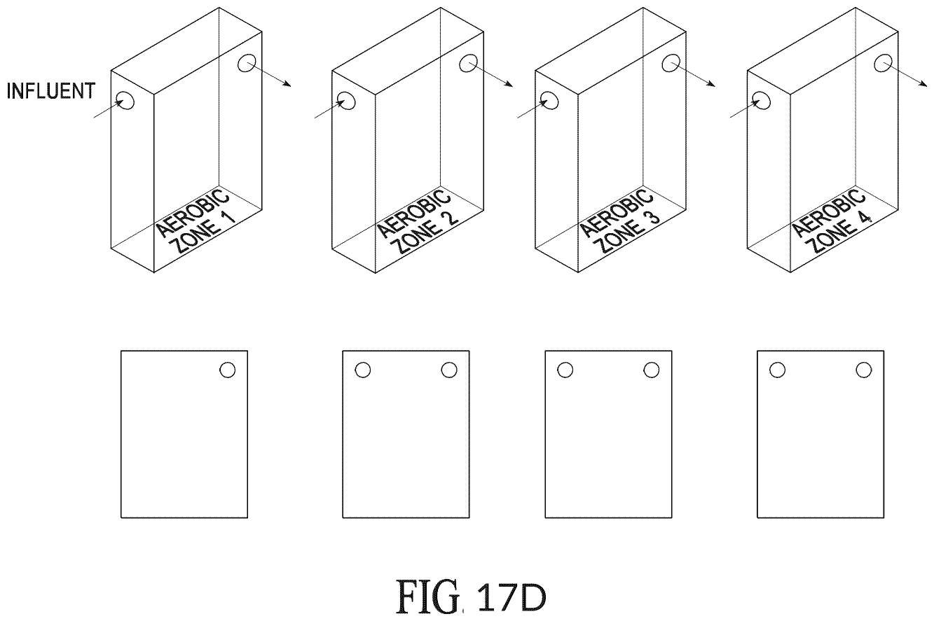

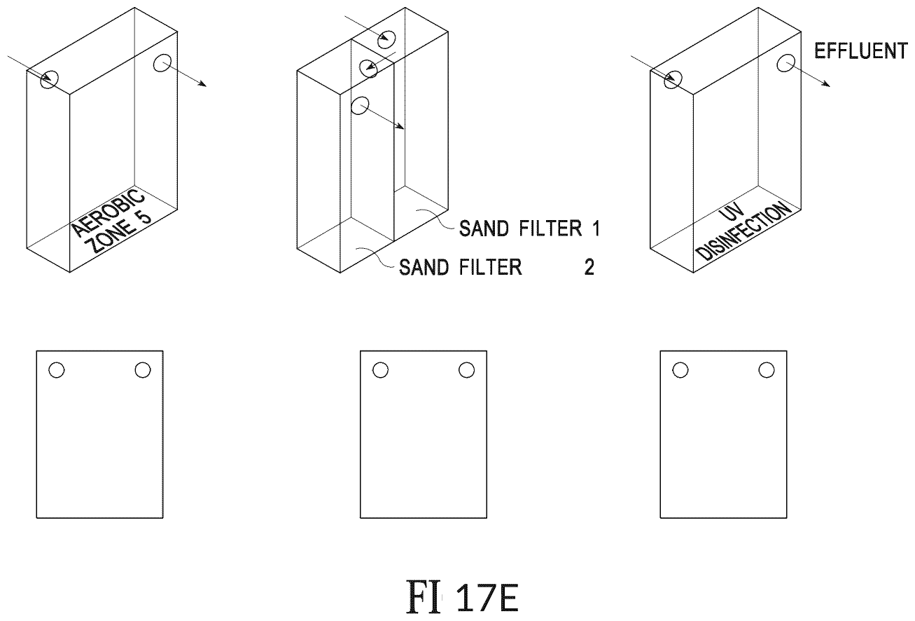

FIGS. 17A-17E are representative plan, profile, isometric and partial process flow views, respectively, for an embodiment of a 300-gallon per day, 8-stage bioreactor “Micro STP” home septic unit of the present invention. The PLAN VIEW shows the 8-chamber reactor. Zones 1-5 are aerobic, followed by 2 sand filters and then a UV disinfection stage. The overall length is 6 feet, the overall width is 2.5 feet, and the overall height is 3.28 feet.
AEROBIC ZONE 1:6 hrs HRT, 61.34 gal CAP, 2.50 ft×1.0 ft×3.28 ft
AEROBIC ZONE 2:6 hrs HRT, 61.34 gal CAP, 2.50 ft×1.0 ft×3.28 ft
AEROBIC ZONE 3:6 hrs HRT, 61.34 gal CAP, 2.50 ft×1.0 ft×3.28 ft
AEROBIC ZONE 4:6 hrs HRT, 61.34 gal CAP, 2.50 ft×1.0 ft×3.28 ft
AEROBIC ZONE 5:6 hrs HRT, 61.34 gal CAP, 2.50 ft×1.0 ft×3.28 ft
SAND FILTER 1: 30 mins HRT, 15.34 gal CAP, 1.25 ft×0.50 ft×3.28 ft
SAND FILTER 2: 30 mins HRT, 15.34 gal CAP, 1.25 ft×0.50 ft×3.28 ft
UV DISINFECTION: 30.67 gal CAP, 2.50 ft×0.50 ft×3.28 ft

### Summary

In conclusion, BioCleaner's Micro STPTM miniature sewage treatment plant can eliminate odor and nutrients that can harm human beings and nature. It is also concluded that the waste water generates no sludge and has very clear discharge. With the proper operation in quantity of retention time and ensuring amount of aeration in the unit.

### Septic Tank Bioreactor Unit

Another embodiment of the present invention is a unit which is essentially a small bioreactor that has an aeration mixing unit.

This unit is designed to work in a septic tank. Typically, a septic tank will have 2 to 3 chambers, while the older ones have a single chamber. Typical systems are designed for 10 people at 50 gallons per person, so typically these systems are designed to process 500 gallons per day of sewage.

The first chamber is called the reactor chamber and this is typically 1000 gallons or 2 days or retention time. A size of 1000 gallons for a single family residence septic tank is typical, and calculating based on a 2-day retention time, accommodates up to 10 people per day based upon an approximate production rate of 50 gallons of wastewater per day per person. For septic systems manufactured or built in the 1970s, these typically have a second chamber that is 12 hours or 250 gallons. This is called the polishing chamber and its usually anoxic. In more recent designs, the septic tank will have a third chamber called a leaching chamber, approx. 250 gallons, and it will lead the water to a drain field, holding tank or recycle loop where the water is returned to a closed system.

The present invention works within the confines and design of existing septic tanks. It will also be noted that many countries around the world only use 24 hours of HRT or retention time. Hydraulic Retention Time or HRT is the average length of time that a soluble compound remains in the bioreactor, defined as the volume of the aeration tank divided by the influent flow rate, and controls the time for sorption and biodegradation in water.

The septic bioreactor of the present invention is constructed so that it will be hanging from the lid of a septic tank and it will be suspended in the water. The aeration side will be 8 to 10 inches under water. As the bioreactor releases microbes, the aeration mixer module aerates and by virtue of gravity moves the water up. Finally, the confined spaces of the first chamber or reactor chamber will make the water mix inside the reactor chamber.

The following describes how the present invention gets rid of BOD, TSS, Ammonia, Odor, FOG, Total nitrogen, lowers fecal coliform counts, eliminates toilet and tissue paper, and helps to prevent clogging of the system components.

### Coliform

The microbes generated by the bioreactors of the present invention are biosafety level 1 microbes. They are facultative and will out compete fecal coliform in this system, though coliform are aerobic in nature. This will starve out the fecal coliform in the first chamber and the anoxic nature of the second chamber will make it harder for the fecal coliform to compete against the facultative microbes from our bioreactor.

### Sludge, Toilet Paper

The microbes used in the present invention are also saprophytes, i.e., they eat dead matter, such as composting microbes. These microbes “chew up” the sludge and beak down tissue and toilet paper. Food waste will also be broken down, except seeds as seeds are considered alive.

### BOD, COD, TSS

The sugars or food particles found in sewage contribute to the biological oxygen demand (or BOD) of the waste stream. These materials are broken down by the microbes coupled with aeration. This prevents methane production and will just produce carbon dioxide. Total suspended solids (TSS) are defined as solids in water that can be trapped by a filter. By use of the present invention, TSS in wastewater can be reduced by the action of oxidizing, physical filtration, coagulation or flocculation. Aerobic and anaerobic treatments significantly reduce TSS.

### Odor

In an embodiment of the present invention, the reactor chamber will be aerobic and will take up the sulphur in the bodies of these microbes. so there will be no odor as conditions for odor will not exist in the first chamber.

### FOG and Clogging

FOG is an acronym for Fats, Oils and Grease that are deposited into a sanitary sewer

system. FOG typically comes from meat fats in cooking and food scraps, cooking oil, shortening, lard, butter and margarine, gravy, and food products such as mayonnaise, salad dressings, sour cream and other foods high in fat. Over time FOG can build up and block entire pipes, this excessive accumulation will restrict the flow of wastewater and can lead to serious problems with the overall sanitation system.

Some of the microbes used in the present invention produce lipase enzymes. These enzymes will break down fats into fatty acids. Other microbes will consume and break down fatty acids.

Furthermore, as the FOG are processed or “chewed up”, this will prevent them from clogging up the exit pipes and drain so it will not clog up the tank and the drain field.

### Ammonia and Total Nitrogen

Some of the microbes used in the present invention break down ammonia, even while on a chemosynthetic mode. Oxygen is needed as it is a chemical balance issue. Therefore, the aeration mixer unit is recalculated to deliver enough dissolved oxygen to not only break down BOD and sludge but also to break down ammonia into nitrites and nitrates in the first chamber.

As the water containing the nitrates exit the chamber and enters the anoxic chamber for polishing, the nitrates due to gravity will settle to the bottom. There, the microbes which are facultative, will search for oxygen. Through the process of anaerobic respiration, taking the oxygen from the nitrates and releasing both carbon dioxide and elemental nitrogen to the atmosphere.

The system and methods of the present invention will remove over 90% of the nitrogen of the waste water.

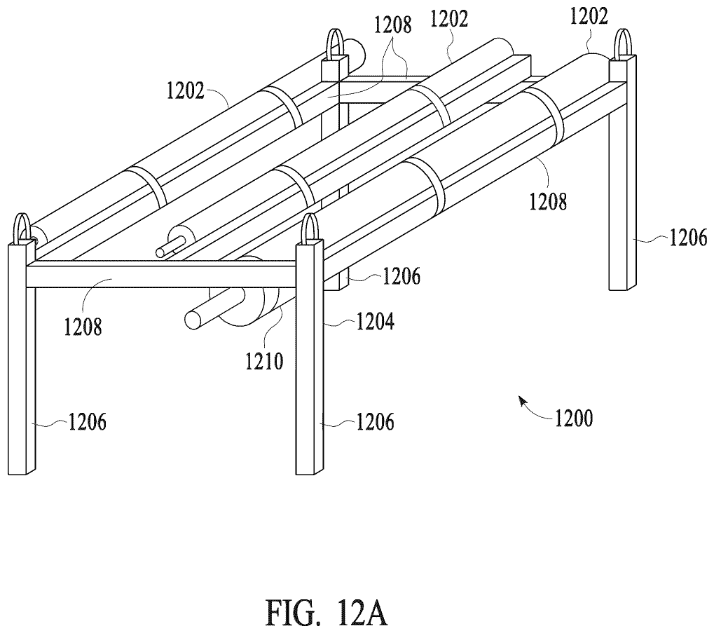

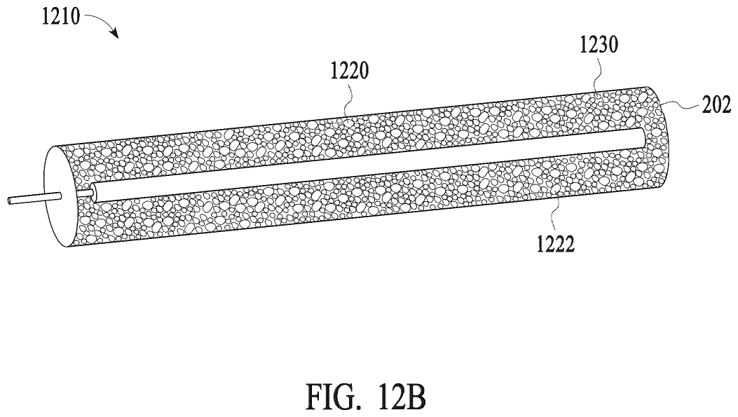

FIG. 12A is a representative view of a septic tank bioreactor unit 1200 of the present

invention. FIG. 12B is a representative view of a tubular seeder reactor 1210 of the present invention.

The septic tank bioreactor unit 1200 of the present invention is comprised of a unit featuring three strips 1202 of aeration and the tubular seeder reactor 1210 situated in the middle. The unit's robust and corrosion-resistant stainless steel frame 1204 comprising 4 sturdy legs 1206 and one or more sets of rigid crossbars 1208 as shown. A preferred embodiment of the frame portion 1204 measures 15 inches in length and width and 6 inches in height. The upper aeration tubes 1202 are suspended 4-6 inches under the water surface within the septic tank (not shown). Four stabilizing cables (also not shown) attach to U-hooks 1212 or similar coupling means located at end points along the upper crossbars 1208 maintain its balance and keep it in position, and the inclusion of legs 1206 not only stabilizes the unit 1200 but also lowers its center of gravity, ensuring optimal performance. Hose clamps or cable ties 1214 couple the aeration tubes 1202 to the crossbars 1208 of the frame 1204.

For efficient aeration system, whether it is an aeration system or device splashes, sprays, or diffuses air, an important factor is how much surface area it creates. The surface area is where water/liquid medium contacts air and where oxygen transfer takes place. Smaller bubble size results in more surface area, which is why fine bubble aeration devices are superior in oxygen transfer than coarse bubble aerators. To maximize aeration efficiency in a system, an aerator must create fine bubbles while expending a minimum amount of energy. The main purpose is to have a high SOTR and SAE for the aeration system.

In embodiments of the bioreactor septic unit 1200 of the present invention, there are a number of commercially available diffuser tubes and grids 1202 that can be incorporated in the bioreactor system 1200 of the present invention. Most of these models resemble what has been disclosed in U.S. Pat. No. 5,811,164, issued Sep. 22, 1998 to Mitchell entitled “AERATION PIPE AND METHOD OF MAKING SAME”, which is incorporated herein by reference in its entirety. One of the commercial models is Aero-TubeTM diffuser grids. One of the most important structure for the extremely high performance and efficiency of aeration tubes and grids 1202 is the adaptation of internal hose segments (not shown) which, through a unique combination of technique and raw material, creates numerous micro-pores throughout the length of hose segments. These micro-pores create tiny air bubbles and hence high surface area, which allows the efficient transfer of air into the water. In one embodiment, aeration tubes and grids 1202 are made up of hose segments. Preferably, these hose segments are made from thermoset polymer particles in a matrix of thermoplastic binder material, which may be made according to a method described in the '164 patent.

Due to the number of pores created during the manufacturing process, there is little resistance created when pushing air through aeration tubes 1202. Resistance equals energy demand hence aeration tubes 1202 use significantly less horsepower when compared with traditional methods of aeration such as bubblers, paddlewheels, aspirators, less efficient tubing, etc. Moreover, aeration tubes 1202 contain tiny pore size which creates bubbles with extremely small diameters. The smaller the gas bubbles, the more efficiently they transfer oxygen into water. Small bubbles also take longer to rise once they are introduced into water. Slower rising, small-diameter bubbles mean more contact with the water and a much higher rate of oxygen transfer. By creating significantly smaller bubbles, more efficiently, aeration tubes 1202 are able to deliver high rates of oxygen transfer [SOTR] and energy efficiency [SAE].

The tubular seeder reactor 1210 is a pivotal element within the system, featuring media rich in diverse microbes. This dynamic microbial environment accelerates the breakdown of waste components such as FOG, nitrates, and other organic matter. The aeration process, driven by the three aeration strips 1202 and aided by a small linear air pump with a maximum capacity of 40 W, not only makes the water less dense but also promotes efficient oxygenation throughout the septic tank.

The tubular seeder bioreactor 1210 is a bioreactor paired with an aeration tube or grid 1202 such as a microbubble generator. The purpose of the microbubble generator 1202 is to generate highly oxygenated water which infuses microbes contained within the tubular reactor 1210 with the nutrients required to achieve very high levels of process and treatment effectiveness and efficiency. The accelerated regeneration of microbes resident within the tubular seeder reactor 1210 accelerates the natural mineralization process, reducing treatment cycle times and virtually eliminating organic contaminant levels.

The tubular seeder reactor 1210, in one embodiment, in situ bioreactor tube container 1210 has an external slotted pipe structure which has lots of inner bores 1220. Within each inner bore 1220, enough microbial media 1222 should be loaded. In one embodiment, there is aeration tubing 1230 embedded within the slotted pipe structure 1220. One end of aeration tubing 1230 is connected to bioreactor pump (not shown). When the bioreactor pump is on, it supplies air through aeration tubing 1230 which tiny air bubbles are created. Air bubbles diffuse from the internal to the external surfaces of tubular bioreactor 1210 and ultimately disperse to the surrounding water/liquid medium via numerous inner bores 1220 where microbial media 1222 are contained. The air bubbles supply both oxygen and nutrients to microbial media 1222 and eventually disperse them into the surrounding water/liquid medium.

Inventor's prior U.S. Pat. Nos. 8,066,873, 8,992,772 and 9,655,349 teach floating bioreactors and bioreactors for septic tanks and aquariums which utilize an embodiment of the tubular seeder reactor 1210, and are incorporated herein in their entireties by reference.

During aeration, the mixing process pulls water from the bottom of the septic tank, permeating the entire septic tank. The dissolved oxygen levels at the top of the tank are significantly higher than at the bottom, creating an ideal environment for microbial activity. This aeration process, coupled with the tubular seeder reactor 1210 and the stainless steel frame 1204, contributes to the reduction of foul odors and lowers both BOD and COD levels.

The septic tank bioreactor unit 1200 of the present invention employs a facultative microbial treatment strategy, utilizing different microbial strains present in the tubular seeder reactor 1210 to address various waste components. Some microbes focus on breaking down FOG, while others perform nitrification. Additionally, the system 1200 efficiently degrades toilet paper, sludge, and other food waste.

The treatment process begins with the disposal of waste, allowing most solids to settle at the bottom of the tank. The second chamber, designed to be anoxic, fosters denitrification by facultative microbes. The treated water then flows into the third chamber, facilitating the leaching process before eventual discharge.

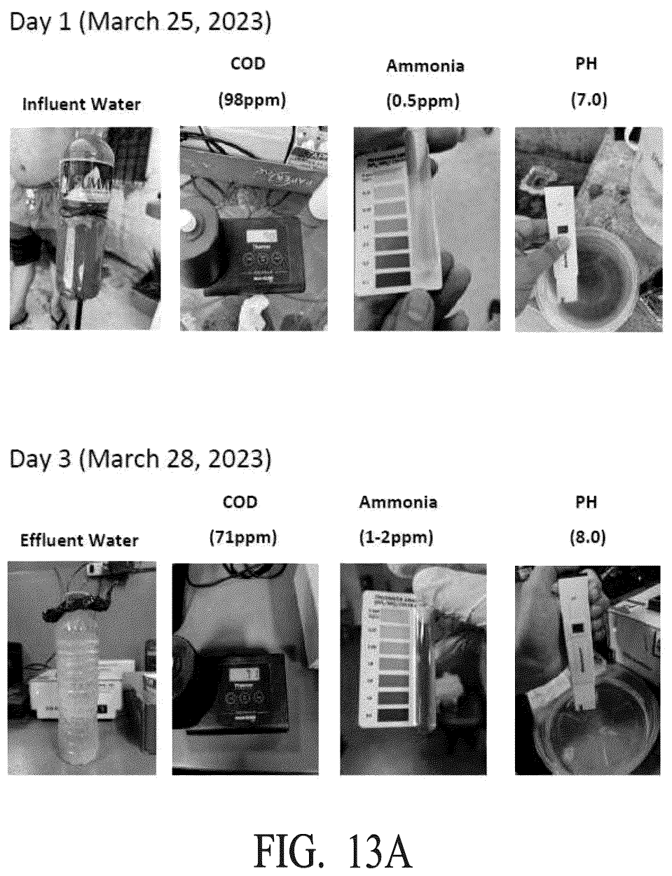

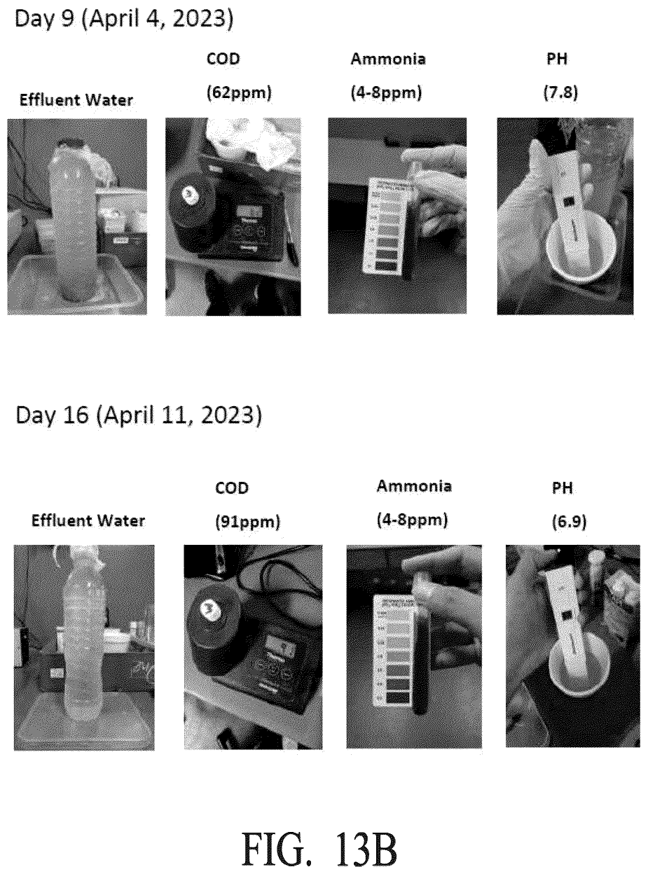

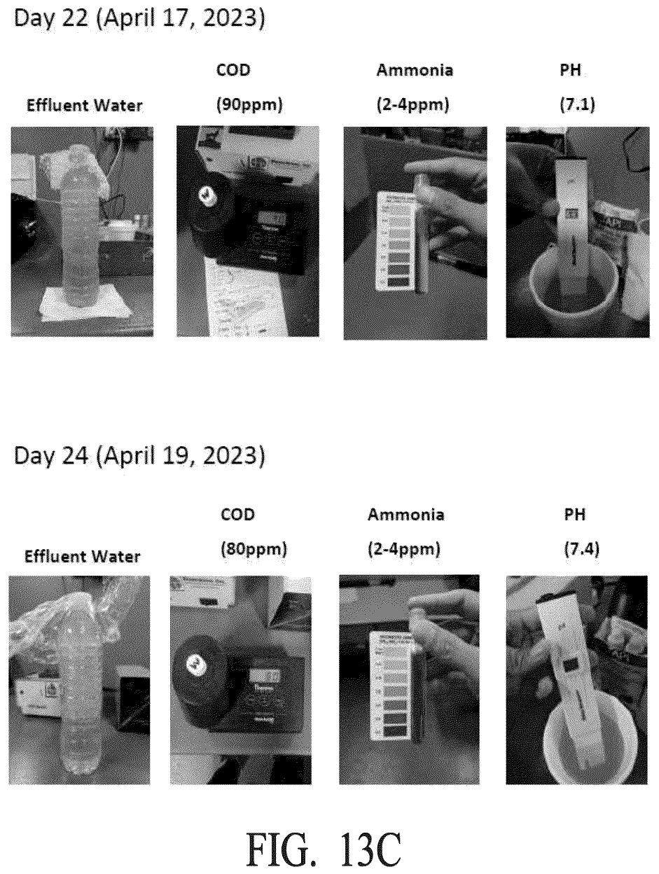

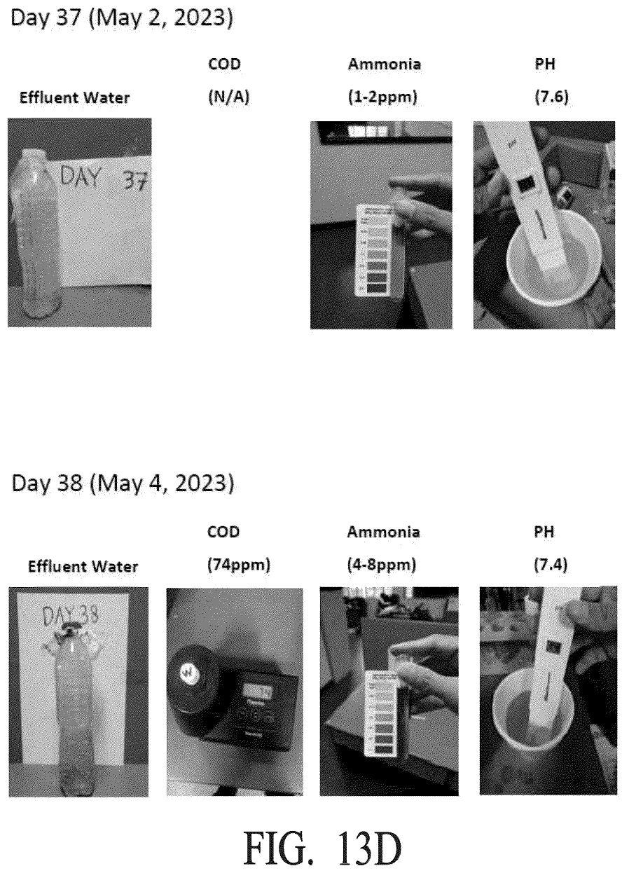

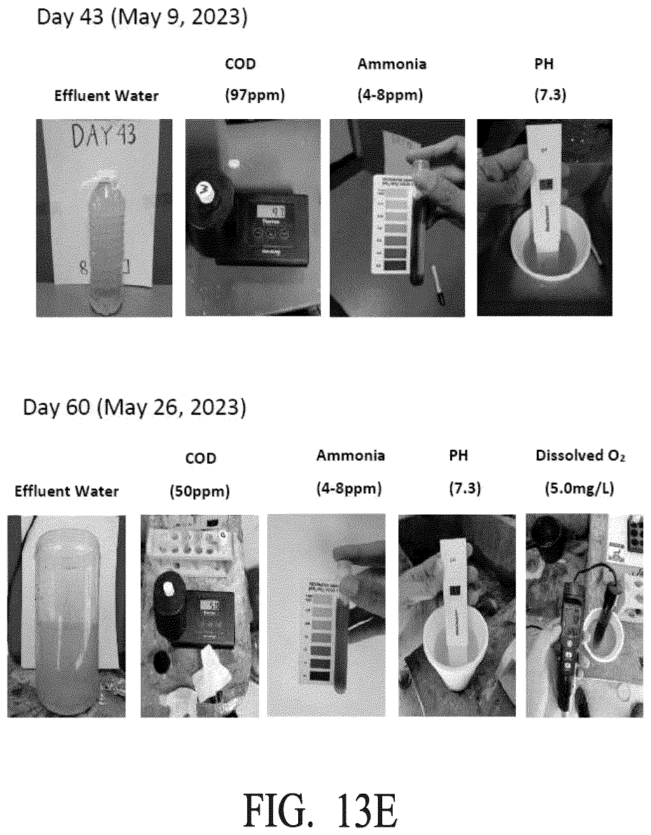

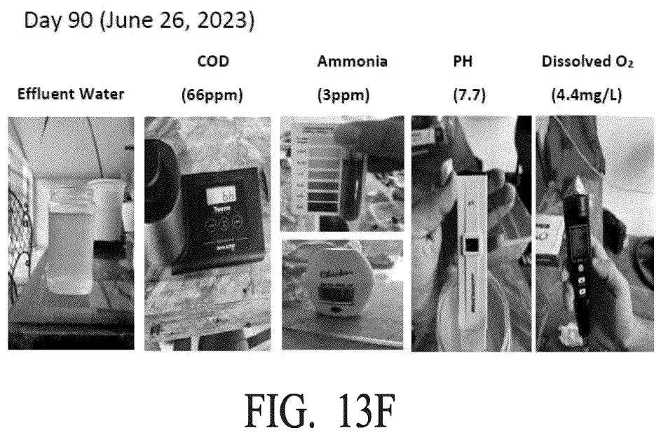

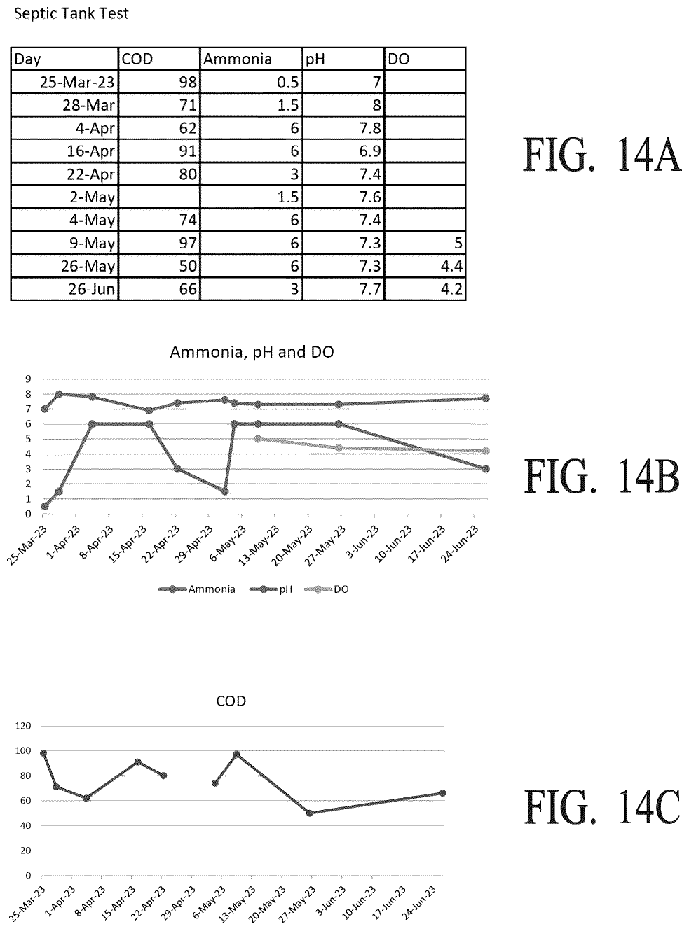

FIG. 13A-13F are photographical representations of experimental results obtained from use of the septic tank bioreactor unit of the present invention.

FIG. 14A is a table of data from experimental results obtained from use of the septic tank bioreactor unit of the present invention. It will be understood that the data represents water sampling taken over a total of 90 days.

FIGS. 14B and 14C are plots of data from experimental results obtained from use of the septic tank bioreactor unit of the present invention. FIG. 14B shows concentration of ammonia, pH and dissolved oxygen, or DO, in the septic tank over the period of time of 90 days. FIG. 14C shows chemical oxygen demand, or COD, in the septic tank over the period of time of 90 days.

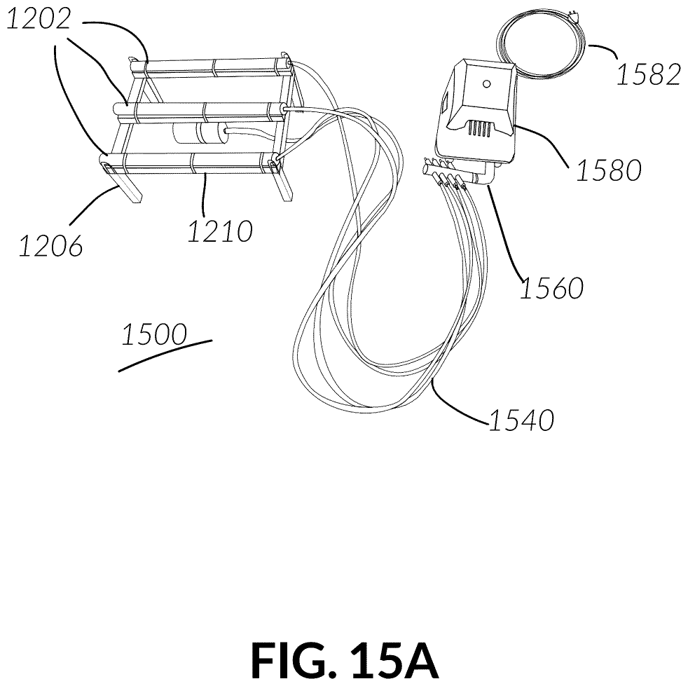

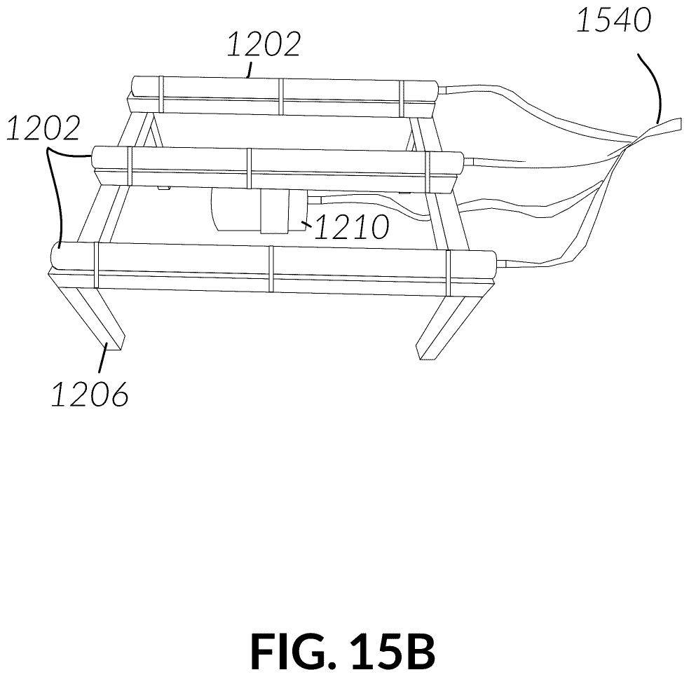

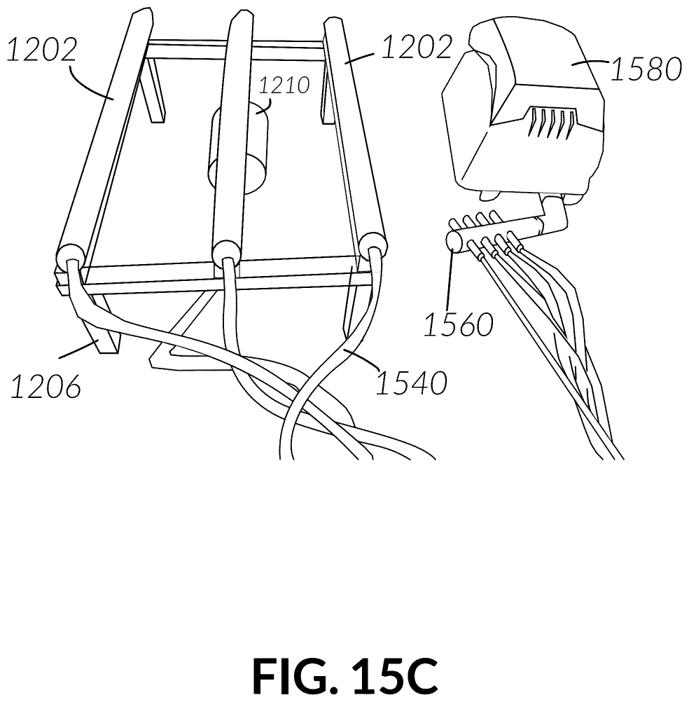

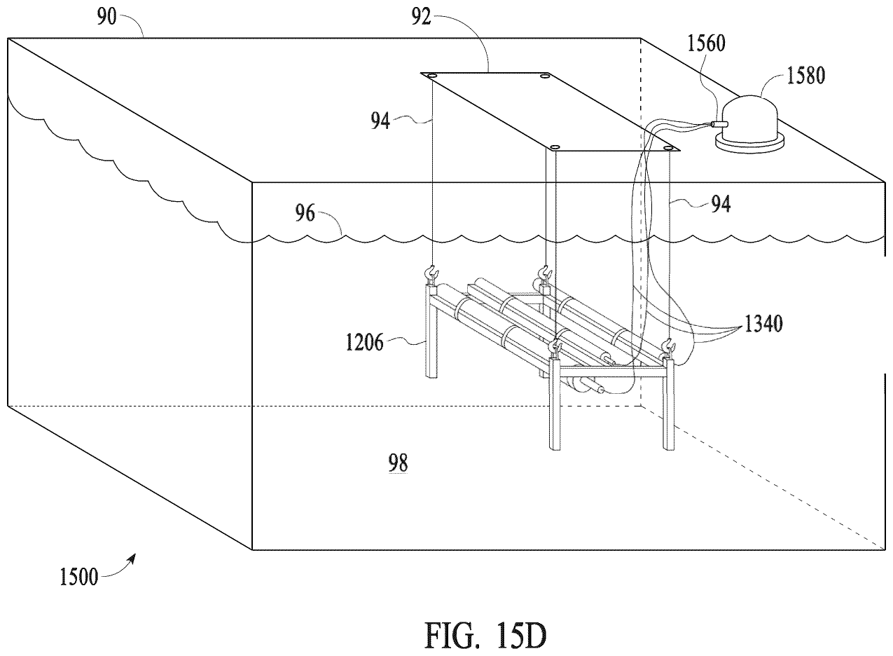

FIGS. 15A-D are further representations of the component parts of the septic tank bioreactor unit 1500 of the present invention and it's configuration in use. As described above, the bioreactor septic unit 1200 comprises a main rigid frame portion 1204, several diffuser aeration and diffuser tubes and grids 1202, a tubular seeder reactor 1210 to maintain a viable, continuously growing bioculture, a series of flexible tubing air lines 1540 connected between the aeration tubes 1230 (shown in FIG. 12B) and an air manifold 1560, and an air pump 1580 with AC power connector 1582.

The septic tank bioreactor unit 1500 of the present invention is suspended within a conventional, pre-existing or newly constructed septic tank 90. Access to the unit 1500 is through a manhole with manhole cover 92. Frame 1206, diffuser tubes and grids 1202 and tubular seeder reactor 1210 are all suspended below the surface 96 of water to be treated 98 by chains or cables 94 or similar. The series of flexible tubing air lines 1540 lead from the grids 1202 and frame 1206 and tubular reactor 1210 portions of the unit 1200 below the surface 96 of the water 98 up to the air manifold portion 1560 and air pump 1580 mounted distally from the rest of the system 1200.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A bioreactor home septic unit for treatment of septic waste, the bioreactor home septic unit comprising:
An inlet for intake of untreated septic waste influent;
A first aerobic treatment zone fluidically connected to the effluent inlet, the first treatment zone containing a first air diffuser and a first bioreactor;
A second aerobic treatment zone fluidically connected to the first treatment zone, the second treatment zone containing a second air diffuser and a second bioreactor;
A third aerobic treatment zone fluidically connected to the second treatment zone, the third treatment zone containing a third air diffuser and a third bioreactor;
A fourth aerobic treatment zone fluidically connected to the third treatment zone, the fourth treatment zone containing a fourth air diffuser and a fourth bioreactor;
A fifth aerobic treatment zone fluidically connected to the fourth treatment zone, the fifth treatment zone containing a fifth air diffuser and a fifth bioreactor;
Each of the first, second, third, fourth and fifth bioreactors containing filter medium and living microbes suspended within the filter medium;
Each of the first, second, third, fourth and fifth bioreactors further having a perforated exterior shell, wherein as the living microbes regenerate and multiply within the first, second, third, fourth and fifth bioreactors, a portion of the living microbes are released into the septic waste within the first, second, third, fourth and fifth treatment zones of the home septic unit;
A first sand filter zone fluidically connected to the fifth treatment zone, the first sand filter zone containing sand;
A second sand filter zone fluidically connected to the first sand filter zone, the second sand filter zone containing sand;
A UV disinfectant zone fluidically connected to the second sand filter zone, the UV disinfectant zone containing a source of UV light; and
An outlet fluidically connected to the UV disinfectant zone, the outlet for removal of effluent from the bioreactor home septic system, wherein the microbes break down biological and chemical waste and digest solid waste.

2. The bioreactor home septic unit of claim 1, wherein untreated septic waste influent having an ammonia content as high as 8.0 mg/L is treated to produce an effluent having ammonia content of 0.0 mg/L.

3. The bioreactor home septic unit of claim 1, wherein untreated septic waste influent having a COD of as high as 250 mg/L is treated to produce an effluent having COD of 0.0 mg/L.

4. The bioreactor home septic unit of claim 1, wherein untreated septic waste influent having a strong, foul odor is treated to produce an odorless effluent.

5. The bioreactor home septic unit of claim 1 wherein the bioreactor home septic unit treats approximately 500 gallons of septic waste per day.

6. The bioreactor home septic unit of claim 1 wherein the microbes in the first, second, third, fourth and fifth bioreactors produce lipase enzymes that process FOGs present in the septic waste.

7. The bioreactor home septic unit of claim 1 wherein the first, second, third, fourth and fifth bioreactors contain saprophytic microbes that digest and remove sludge and waste paper products from the septic waste.

8. The bioreactor home septic unit of claim 1 wherein the first, second, third, fourth and fifth bioreactors contain aerobic microbes that are also facultative and out compete fecal coliform and other toxic or hazardous bacteria within the septic waste.

9. The bioreactor home septic unit of claim 1 wherein the microbes contained within the first, second, third, fourth and fifth bioreactors break down sugars and other food particles and thereby reduce the BOD of the septic waste being treated.

10. The bioreactor home septic unit of claim 1 wherein the microbes contained within the first, second, third, fourth and fifth bioreactors reduce the BOD of the septic waste being treated by at least 80%.

11. The bioreactor home septic unit of claim 1 wherein the microbes contained within the first, second, third, fourth and fifth bioreactors reduce the BOD of the septic waste being treated from 300 to 20.

12. The bioreactor home septic unit of claim 1 untreated septic waste influent having a BOD of about 300 is processed to produce an effluent having a BOD of about 20.

13. The bioreactor home septic unit of claim 1 wherein the microbes contained within the first, second, third, fourth and fifth bioreactors break down chemicals and thereby reduce the COD of the septic waste being treated.

14. The bioreactor home septic unit of claim 1 wherein the microbes contained within the first, second, third, fourth and fifth bioreactors reduce the COD of the septic waste by at least 80%.

15. The bioreactor home septic unit of claim 1 wherein the microbes contained within the first, second, third, fourth and fifth bioreactors reduce the COD of the septic waste being treated from 500 to 100.

16. The bioreactor home septic unit of claim 1 wherein untreated septic waste having a COD of about 500 is processed to produce an effluent having a COD of about 80.

17. The bioreactor home septic unit of claim 1, wherein untreated septic waste having low dissolved oxygen is processed to produce an effluent having DO of about 5.0 mg/L.

18. The bioreactor home septic unit of claim 1 wherein the microbes contained within the first, second, third, fourth and fifth bioreactors metabolize odor-causing sulphur found in the septic waste being treated.

19. The bioreactor home septic unit of claim 1 wherein the microbes contained within the first, second, third, fourth and fifth bioreactors break down ammonia in the septic waste being treated into less-reactive nitrates and nitrites.

20. The bioreactor home septic unit of claim 1 untreated septic waste having an ammonia content of about 40 is processed to produce an effluent having an ammonia content of less than about 8.

21. The bioreactor home septic unit of claim 1 wherein at least about 80-90% of the nitrogen in the untreated septic waste is removed.

22. The bioreactor home septic unit of claim 1 wherein the SOTR is at least about 1.0 kg per day.

23. The bioreactor home septic unit of claim 1 further comprising a source of compressed air controllably coupled to air inlets on each of the first, second, third, fourth and fifth aerators.

24. The bioreactor home septic unit of claim 1 wherein a plurality of tubing sections couple the source of compressed air to the air inlets on each of the first, second, third, fourth and fifth aerators.

25. The bioreactor home septic unit of claim 1 wherein a multi-channel air manifold couples the source of compressed air to the plurality of tubing sections coupled to the air inlets on each of the first, second, third, fourth and fifth aerators.

26. The bioreactor home septic unit of claim 23 wherein the source of compressed air is positioned externally to the septic tank installation.
